(19) United States
(12) Patent Application Publication
(10) Pub. No.: US 2007/0162642 A1
(43) Pub. Date: Jul. 12, 2007

(54) A DMA CONTROLLER WITH MULTIPLE INTRA-CHANNEL SOFTWARE REQUEST SUPPORT

(76) Inventor: Ivo Tousek, Stockholm (SE)

Correspondence Address: BAKER & MCKENZIE LLP, Pennzoil Place, South Tower, 711 Louisiana, Suite 3400, HOUSTON, TX, 77002-2716, US

(21) Appl. No.: 11/467,462

(22) Filed: Aug. 25, 2006

Related U.S. Application Data
(60) Provisional application No. 60/751,718, filed on Dec. 19, 2005.

(51) Int. Cl. G06F 13/28

(52) U.S. Cl. 710/22

(57) ABSTRACT

A direct memory access (DMA) controller supporting multiple outstanding software requests in the same channel (intra-channel) is disclosed. The DMA controller comprises a plurality of channel configuration registers, a channel request arbiter, a tail search unit, a channel prediction unit, a command/request entry generator and a request queue. The channel configuration registers output a set of actual channel parameters, the channel prediction unit generates a set of predicted channel parameters, and the command/request entry generator sends a request to the request queue based on the output of the tail search unit. The command/request entry generator uses actual channel parameters to generate control commands and requests if valid outstanding intra-channel requests are not found during the tail search of the presently outstanding requests in the DMA controller; otherwise, the command/request entry generator uses predicted channel parameters from the most recently scheduled intra-channel software request.

This application claims the benefit of U.S. Provisional Application No. 60/751,718 filed Dec. 19, 2005.

### BACKGROUND OF THE INVENTION

1. Field of the Invention

This invention relates to data transfers, and more particularly to a direct memory access (DMA) controller that is optimized for fast memory-to-memory transfers by implementing support for multiple outstanding intra-channel (same DMA channel) software requests.

2. Description of the Related Art

The transfer of data between page mode access primary storage and secondary storage in the form of a data storage device is advantageously performed by DMA, which is a technique for moving data by means of a DMA controller, without any interaction from a processor. DMA operations are initiated by the processor, but do not require the processor for the data transfer. A DMA device is a device which incorporates a DMA controller and is thus able to transfer data directly from the secondary storage, such as a disk, to a primary storage.

The DMA controller performs DMA transfers by servicing DMA requests. DMA requests can be software requests or hardware requests. DMA transfers to/from system peripherals are associated with DMA hardware requests that are generated by system peripherals and driven to the DMA controller. Memory-to-memory DMA transfers are associated with software requests. Large DMA transfers are broken up into smaller data packets, which are sent as bursts on the system's data buses; each such data packet or burst being associated with one DMA hardware or software request.

Referring now to FIG. 1, there is illustrated a schematic diagram of a DMA controller. The DMA controller 100 provides a number of DMA channels which are configurable over the CPU bus. In this example DMA controller, a DMA channel can be configured in the channel configuration registers 112 to transfer data between “local memory” and external system memory connected to the system bus. The DMA controller 100 may include several blocks such as a bus interface unit 110, a DMA en-queue engine 130, a DMA de-queue engine 150, a DMA queue manager 170 and a system bus interface 190 to process the data transfer.

Internally, the DMA controller 100 manages a number of data and control information queues. The DMA controller's channel request arbiter 134 arbitrates among active DMA transfer requests associated with all of its active DMA channels in its channel configuration register 112, each such request being associated with the transfer of one data packet from local memory to external system memory (DMA write), or, from external system memory to local memory (DMA read). For each selected DMA (write or read) request from the channel request arbiter 134, the en-queue engine 130 will schedule one data packet for DMA transfer. Associated with each selected request, the en-queue engine 130 writes one control information entry into a request queue FIFO (reqQ) 132 and one control information entry into a command queue FIFO (cmdQ) 174. Furthermore, for every selected DMA write request the en-queue engine 130 will read data from a local memory (not shown) and place it into the write data queue (wdQ) 172. An entry in the command queue (cmdQ) 174 controls how each scheduled data packet shall be sent over the system bus. Data received over the system bus from external system memory is placed into the read data queue (rdQ) 176. System bus transfer OKAY/ABORTED status information associated with both DMA write and read transfers is placed into a response queue FIFO (respQ) 178, such status information being derived from response information signals on the system bus, such response signals being associated with every data transfer on the system bus indicating if the data transfer is successfully transferred (OKAY) or not (ABORTED). All entries in the reqQ 132 correspond to requests that have been scheduled for service and are presently outstanding in the DMA controller's internal queues. Each entry in the reqQ 132 consists of descriptors that characterize the scheduled DMA request. The DMA controller 100 performs all such entries in the reqQ 132 in-order. The de-queue engine 150 matches an entry in the head of the reqQ 132 against responses in the respQ 178. Data associated with a DMA read transfer is transferred form the rdQ 176 to local memory. When all responses associated with one DMA request have been processed, the entry in the head of the reqQ 132 is removed from the reqQ and the associated DMA channel configuration parameters are updated to reflect data that has been successfully transferred over the system bus. If a data packet, or parts of a data packet, was not successfully transferred over the system bus, then the DMA channel is disabled for further transfer and its configuration parameters are updated to reflect the first data transfer that was aborted over the system bus.

A DMA controller usually supports multiple DMA channels, for example, 8 channels. Internal buffers are usually dimensioned to hold at least one maximum size burst of write data in its outgoing write data buffer (wdQ) and at least one maximum size burst of read data in its incoming read data buffer (rdQ). Due to the dynamics of the queues, one maximum size burst can be in progress of being removed from the respQ/rdQ, while one maximum size burst can also be in progress of being transferred over the system bus and a third maximum size burst can be in progress of being pushed into the cmdQ/wdQ queues.

Multiple requests associated with multiple DMA channels may be outstanding simultaneously within the DMA controller. However, it is often desired that memory-to-memory transfers associated with the same DMA channel be preformed as quickly as possible. The DMA controller is thus desired to be able to handle multiple outstanding intra-channel software requests back-to-back in its internal queues.

However, to support multiple outstanding intra-channel software requests raises many problems. How does the DMA controller calculate the source and destination address of the next request, while other intra-channel requests associated with the same DMA channel are already outstanding in the DMA controller? How does the DMA controller know when the presently last outstanding request will cause the channel to reach its terminal count? These problems associated with multiple outstanding intra-channel software requests exist because the channel parameters are typically not updated until an outstanding request has been completed and the DMA controller has determined if the associated data packet has been successfully transferred over the system bus.

Therefore, there is a need for a DMA controller which can efficiently support multiple outstanding intra-channel software requests to address the above-mentioned problems.

### SUMMARY OF THE INVENTION

The present invention is directed to solving the disadvantages of the prior art. The present invention provides a direct memory access (DMA) controller supporting multiple outstanding software requests in the same channel.

One aspect of the present invention provides a DMA controller which comprises a channel configuration register, a channel request arbiter, a tail search unit, a channel prediction unit, a command/request entry generator and a request queue. The channel configuration register outputs a set of actual channel parameters; the channel prediction unit generates a set of predicted channel parameters; and the command/request entry generator sends a request to the request queue based on the output of the tail search unit. The command/request entry generator uses actual channel parameter values to generate the next command/request if no valid outstanding intra-channel requests are found during the tail search; otherwise, the command/request entry generator uses predicted channel parameter values found during the tail search among the outstanding requests in the reqQ.

Another aspect of the present invention provides an outstanding request queue format of a DMA controller. The outstanding request queue format comprises 1) a predicted terminal count field for predicting whether a particular channel will hit its terminal count following a successful completion of the outstanding request, 2) a predicted byte count field for predicting the remaining number of bytes to be sent following a successful completion of the outstanding request, and 3) two predicted memory address fields for predicting the source and destination memory start address locations for the next intra-channel data packet to be transferred. The predicted values constitute the actual channel parameter values for the next intra-channel data packet to be transferred.

Another aspect of the present invention provides a method for transferring multiple outstanding requests in a DMA controller. The method comprises the steps of providing a channel request, performing a tail search, and executing a request based on the tail search result, using actual channel parameter values to generate the next command/request if no valid outstanding intra-channel requests are found during the tail search; otherwise, using predicted channel parameter values found during the tail search among the outstanding requests in the reqQ.

### BRIEF DESCRIPTION OF THE DRAWINGS

The accompanying drawings are included to provide a further understanding of the present invention, and are incorporated in and constitute a part of this description. The drawings illustrate embodiments of the present invention, and together with the description, serve to explain the principles of the present invention. There is shown:

FIG. 1 illustrates a schematic diagram of a conventional DMA controller;

FIG. 2 illustrates a schematic diagram of a DMA controller according to a preferred embodiment of the present invention;

FIG. 3 illustrates a block diagram of a channel prediction register configuration according to a preferred embodiment of the present invention;

FIG. 4 illustrates a DMA channel parameters update sequence with an ERROR according to an embodiment of the present invention;

FIG. 5 illustrates a flow chart of a sequence of intra-channel packet DMA service according to an embodiment of the present invention;

FIG. 6 illustrates a block diagram of a tail search unit of a DMA controller according to a preferred embodiment of the present invention; and

FIG. 7 illustrates a block diagram of a channel parameter prediction unit of a DMA controller according to a preferred embodiment of the present invention

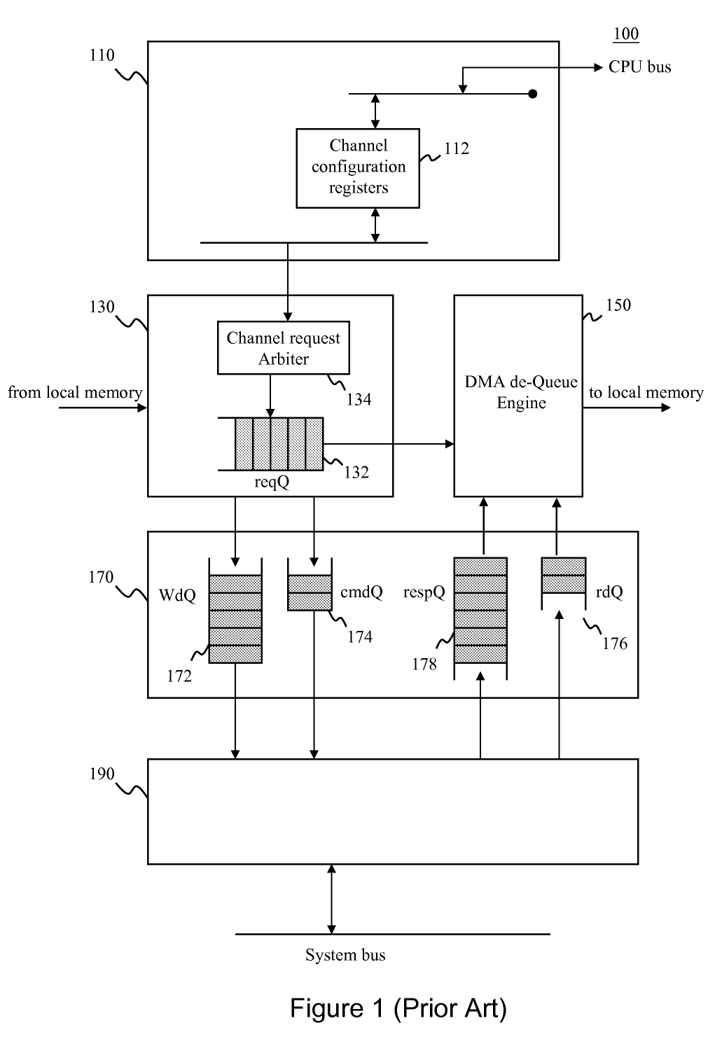

### DESCRIPTION OF THE PREFERRED EMBODIMENTS

The invention disclosed herein is directed to a DMA controller supporting multiple outstanding software requests in the same channel. The DMA controller can dynamically generate a set of predicted channel parameters based on the tail search result. In the following description, numerous details are set forth in order to provide a thorough understanding of the present invention. It will be appreciated by one skilled in the art that variations of these specific details are possible while still achieving the results of the present invention. In other instances, well-known backgrounds are not described in detail in order not to unnecessarily obscure the present invention.

One aspect of the present invention is to calculate predicted parameter values and place them along with a channel number into a request queue (reqQ) as part of the entry when scheduling further requests for service while other requests are already placed in the queue in order to efficiently solve the address calculation and the terminal count problems.

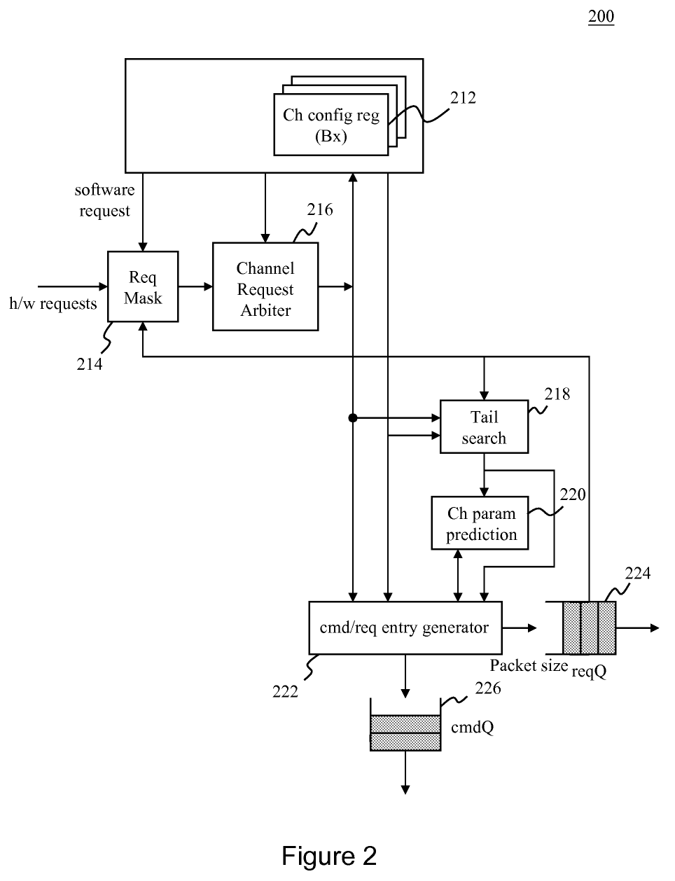

Referring now to FIG. 2, there is illustrated a schematic diagram of a DMA controller according to a preferred embodiment of the present invention. The DMA controller 200 comprises a plurality of channel configuration registers 212, a request mask (Req Mask) unit 214, a channel request arbiter 216, a tail search unit 218, a channel prediction unit 220, a command/request entry generator 222, a request queue (reqQ) 224 and a command queue (cmdQ) 226.

The request mask (Req Mask) unit 214 receives software requests as well as hardware requests associated with active DMA channels, and forwards them into the channel request arbiter 216 for service. When a new software request is selected by the channel request arbiter 216 and is scheduled for service, the command/request entry generator 222 first performs a so-called tail search to see if the selected channel already has any request outstanding in the internal request queue (reqQ) 224. DMA requests that have been scheduled for service and placed into the request queue (reqQ) 224 are executed in order by the DMA controller. During the tail search, the command/request entry generator 222 searches the request queue (reqQ) 224 for a valid entry with the same channel number. In one embodiment, the search is performed among all entries starting from the tail and moving towards the head of the request queue (reqQ) 224 to find the last intra-channel software request that is presently outstanding in the DMA. If such an entry is found, then the tail search stops and the tail search unit 218 forwards that entry's predicted parameter values to the channel parameter prediction unit 220, otherwise the tail search unit 218 forwards the selected channel's actual channel parameter values to the channel parameter prediction logic 220. The channel parameter logic 220 uses the values received from the tail search to predict the new channel parameters associated with the selected (new) software request. The command/request entry generator 222 then generates and en-queues the new request by pushing the associated entry into the request queue (reqQ) 224 and pushing a descriptor into the command queue (cmdQ) 226. In one embodiment, both the request queue (reqQ) and the command queue (cmdQ) are handled on a first in first out (FIFO) basis.

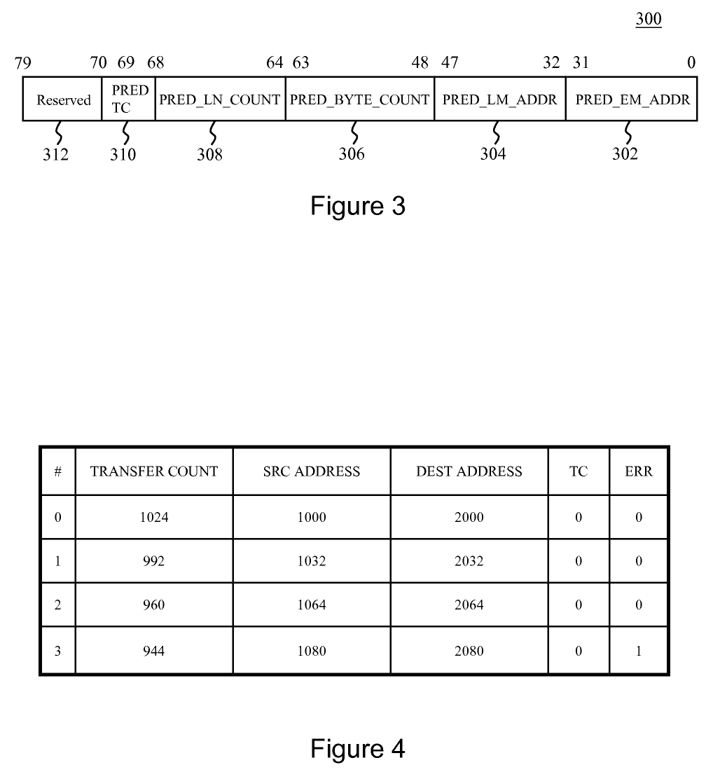

Referring now to FIG. 3, a register configuration is shown representing one entry in the request queue (reqQ) which contains fields for channel prediction according to a preferred embodiment of the present invention. This example implements an intra-channel multiple software request supporting function by associating each entry in the request queue (reqQ) with a single 80-bit register. The request queue entry register 300 comprises at least four fields to represent predicted channel parameters; predicted terminal count, predicted byte count, predicted local memory address, and predicted external memory address, respectively. The first field is a 1-bit predicted terminal count (PRED_TC) 310 which predicts if the channel will hit its terminal count once the associated outstanding request has been completed. The second field is a 16-bit predicted byte count (PRED_BYTE_COUNT) 306 which predicts the remaining number of bytes to send over a particular channel after the associated outstanding request has been completed. The third field is a 16-bit predicted local memory address (PRED_LM_ADDR) 304 which predicts the next memory address in the local memory after the associated outstanding request has been completed. The fourth field is a 32-bit predicted external memory address (PRED_EM_ADDR) 302 which predicts the next memory address in the external memory after the associated outstanding request has been completed. Additionally, a fifth field which is a 5-bit predict line count (PRED_LN_COUNT) 308 can be optionally used when the DMA controller is a fixed offset scatter/gather DMA controller. The predicted line count (PRED_LN_COUNT) 308 predicts the line segment counter value once the associated outstanding request has been completed. The remaining 10 bits are left as reserved field 312. The details of the fixed offset scatter/gather DMA controller can be found in the co-pending application with common assignee, “FIXED OFFSET SCATTER/GATHER DMA CONTROLLER”, docket number VIA 2002. The request entry consists of further information not shown in the figure, such as a valid bit that indicates if the request entry is valid and a channel number information field which associates the entry with one of the DMA controller's channels.

In operation, when a new software request is scheduled for service and the channel has no other outstanding requests as indicated by the tail search 218, the command/request entry generator 222 will generate the command descriptor to the command queue (cmdQ) 226 and perform the channel parameter prediction based on the channel's parameter values in the channel configuration registers 212. On the other hand, when a new software request is scheduled for service while other intra-channel requests are already outstanding as indicated by the tail search 218, the command/request entry generator 222 will generate the command descriptor to the command queue (cmdQ) 226 and perform the new channel parameter prediction based on the most recently predicted channel parameter values from the request queue (reqQ) 224. If the PRED_TC 310 is a one, then the intra-channel software request is masked by the request mask unit 214.

Depending on the functionality provided by the DMA controller, the channel parameter prediction can be enhanced to predict other types of information. One such example is the PRED_LN_COUNT parameter holding the predicted line segment count value, which improves scatter/gather performance in a fixed offset scatter/gather DMA controller which is described in more details in the co-pending application with common assignee, “FIXED OFFSET SCATTER/GATHER DMA CONTROLLER”, docket number VIA 2002%

The DMA controller breaks down DMA transfers into smaller data packets that are transferred as bursts over the system bus. In one embodiment, the system bus is the Advanced High-Perforamnce Bus (AHB) bus. As an example, the DMA controller can transmit and receive data as single, 4-beat or 8-beat bursts of 1-byte, 2-byte or 4-byte transfers. An 8-beat burst of 4-byte transfer is transferring 4 bytes of data in 8 consecutive data clock cycles. During channel configuration, the programmer may decide the DMA transfer count, the source and destination addresses and how the data shall be transferred. As an example, if the transfer count is set to 1024 bytes and an 8-beat bursts of 4-byte transfers shall be used, the DMA controller will break down the transfer into 32 bursts (32*8*4=1024).

The DMA controller continuously updates its channel configuration registers while the bursts are being sent. An important feature of the AHB bus is that each data phase transfer is associated with a response from the receiving end. In a typical case, the DMA controller will send or receive bursts of data with OK responses. In some cases, bursts may be waited or split or retried which means that the burst will be completed later. However, if an ERROR response is received during a DMA transfer over one of its channels, then the DMA controller will disable the DMA channel, update the channel's transfer size, and source and destination address register such that they reflect the amount of data that was successfully sent prior to the ERROR, and set the channel error flag. A data transfer that is associated with an ERROR response is considered aborted. FIG. 4 shows an example where row # 0 corresponds to the programmed value by the user. The values in rows # 1 and # 2 correspond to the updated values following the successful transfer of a burst over the AHB bus. Row # 3 reflects the number of bytes that were successfully delivered to the point where an ERROR response was received. Following the ERROR response, the channel can be serviced by software again.

When a DMA channel is configured to transfer data from a local memory to an external memory, the DMA reads a data packet corresponding to one burst from the local memory and places the data packet into a write request queue (wrQ). The command entry generator generates a write command into the command queue (cmdQ) and a descriptive request entry into the request queue (reqQ). When the burst is transferred over the system bus, responses associated with each data phase transfer flow in an opposite direction through the response queue (respQ). The response parser then provides updated channel information to the channel configuration registers. One command entry, one request entry and one response packet are associated with each write-data packet.

On the other hand, when a DMA channel is configured to transfer data from an external memory to a local memory, the DMA places a read command from the command entry generator into the command queue (cmdQ), and a request entry into the request queue (reqQ). When the burst is transferred over the system bus, read data is placed into the read data queue (rdQ) while the responses are placed into the response queue (respQ). The response parser then to provides updated channel information to the channel configuration registers. Again, one command entry, one request entry and one response packet are associated with each read-data packet.

This invention deals with the design of a DMA controller that is connected to a system bus that supports OKAY/ABORT response signals associated with each data bus transfer. The DMA controller is being optimized for fast memory-to-memory transfers by implementing support for multiple outstanding intra-channel software requests.

It is preferrable to update the transfer count, source and destination address registers, after the burst has been transferred over the bus and the OK/ERROR responses associated with each data phase transfer of that burst have been examined. In particular, if multiple requests belonging to the same DMA channel are outstanding in the DMA controller and one of the associated data transfers is aborted over the bus, it would be difficult to calculate the correct transfer count and the source and destination address registers if those registers are updated immediately when the packet is scheduled for service. Following a DMA data bus transfer that is aborted, the associated DMA channel should be disabled and the values in the channel's transfer count and source and destination address registers should reflect the data that was aborted.

There may be a considerable latency from when a packet is scheduled for DMA transfer until the packet reaches its destination. And multiple outstanding packets may already be scheduled ahead. By updating the channel parameters after the packet has been transferred and checking all responses, the DMA transfer progress can be tracked. The actual channel parameters should always be updated such that they reflect data that has been successfully transferred.

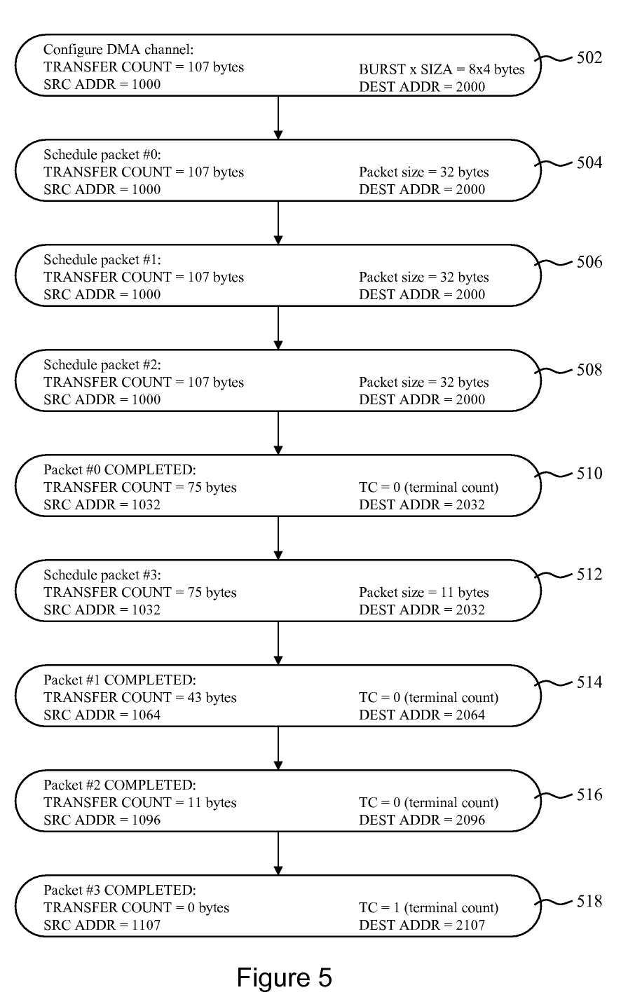

Referring now to FIG. 5, there is illustrated a flow chart of an intra-channel data packet DMA transfer sequence that utilizes multiple outstanding software requests in the DMA controller. The DMA channel is initially configured in step 502 to transfer 107 bytes of data using software requests and 8-beat bursts of 4-byte data transfers. The DMA controller schedules three 32-byte packets for transfer in steps 504, 506 and 508 and a last 11-byte packet for transfer in step 512. The packets are serviced in order and completed one after the other in steps 510, 514, 516 and 518. The channel parameters such as transfer count, source and destination address, and terminal count are updated every time a data packet has completed its transfer and the associated responses have been checked, that is at the end of steps 510, 514, 516 and 518. One will note that packets number #1, #2 and #3 are scheduled for transfer while another intra-channel packet is already outstanding in the DMA controller. Therefore, only when scheduling packet #0 the DMA controller may use the channel's actual parameter values in the channel's configuration registers, while those values are not up-to-date when the DMA controller desires to schedule packets #1, #2 and #3 for DMA service.

Therefore, if multiple intra-channel packets are outstanding in the DMA controller, how does one determine if another intra-channel packet can be scheduled? And if another intra-channel packet can be scheduled, how does one determine the size, the source and destination addresses of the packet?

One way to solve the problem is to provide a set of predicted parameter values associated with each channel as long as the DMA channel has a scheduled packet for transfer that is still outstanding in the DMA controller. While valid, the predicted channel parameters are used every time the DMA channel schedules a new packet for DMA service. The predicted values are the values following a successful completion of the request. Based on the predicted values, all necessary parameters such as the packet size, the source and destination address associated with those packets can be calculated for the next intra-channel packet, while other intra-channel packets are outstanding in the queues. If the maximum supported total number of outstanding packets in the DMA controller are greater than the total number of DMA channels, then the channel prediction parameters can be stored together with each channel's configuration register set. However, when the number of supported channels is greater than the total number of maximum outstanding packets, it is more cost efficient to provide the predicted channel parameters as part of the entry in the request queue (reqQ) of outstanding requests.

The PRED_TC bit 310 is used by the ReqMask unit 214 in FIG. 2. The ReqMask unit 214 monitors all hardware and software request signals associated with active DMA channels, masks certain valid requests and forwards other valid requests as active requests to the Channel Request Arbiter. Hardware requests associated with a DMA channel that already has an outstanding request in the DMA controller are always masked. Software requests on enabled channels are masked if the channel has a valid entry in the request queue (reqQ) and the PRED_TC bit is set to a one.

The Channel Request Arbiter 216 monitors all active requests from the ReqMask unit and selects the next DMA channel number to be serviced. The channel number is used by the tail search unit 218 and the command/request entry generator 222. The channel number is also used to multiplex out the actual channel parameters 212 associated with the selected channel.

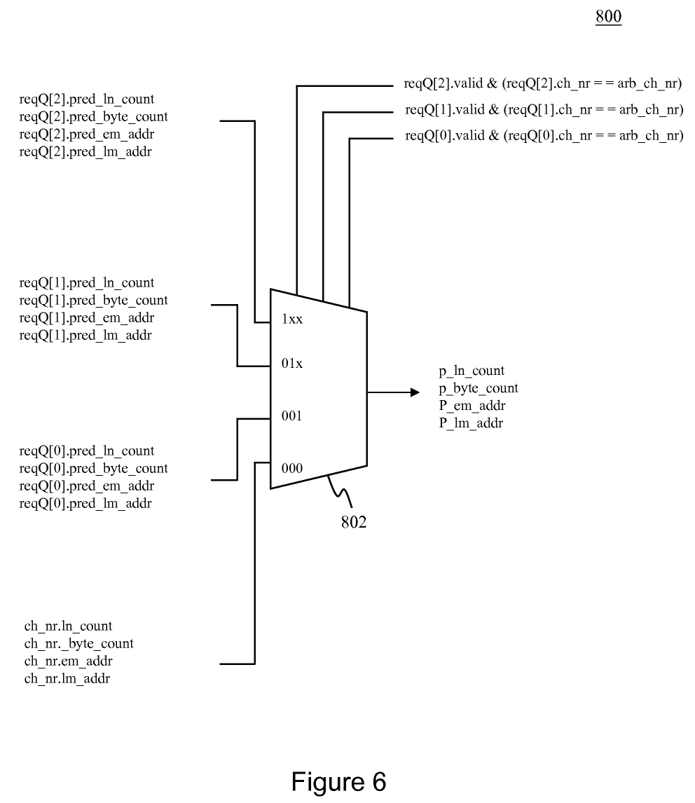

Referring now to FIG. 6, there is illustrated a schematic diagram of a tail search multiplexer according to a preferred embodiment of the present invention. In the example, the tail search unit 800 supports a 3-entry deep request queue (reqQ) FIFO. Inputs to the tail search priority decoder 802 are the predicted channel parameter values, channel number and valid bits from the request queue entries in the request queue (reqQ) 224, where reqQ[2]* denotes parameters from the tail-entry of the reqQ and reqQ[0].* denotes parameters from the head-entry of the reqQ. Inputs to the tail search priority decoder 802 are also the selected channel's actual channel parameter values, denoted ch_nr*, and the selected channel number arb_ch_nr from the channel arbiter 216. The tail search unit 800 produces a number of input parameters (denoted p_X in the figure) based on the most recently predicted intra-channel parameter values generated by the priority decoder 802 if such values exist for the selected channel among the entries in the reqQ, or if it uses the selected channel's actual parameter values. The p_X input parameters such as p_ln count, p_byte_count, p_em_addr, p_lm_addr, are used by the channel parameter prediction logic and the command/request entry generator as mentioned previously.

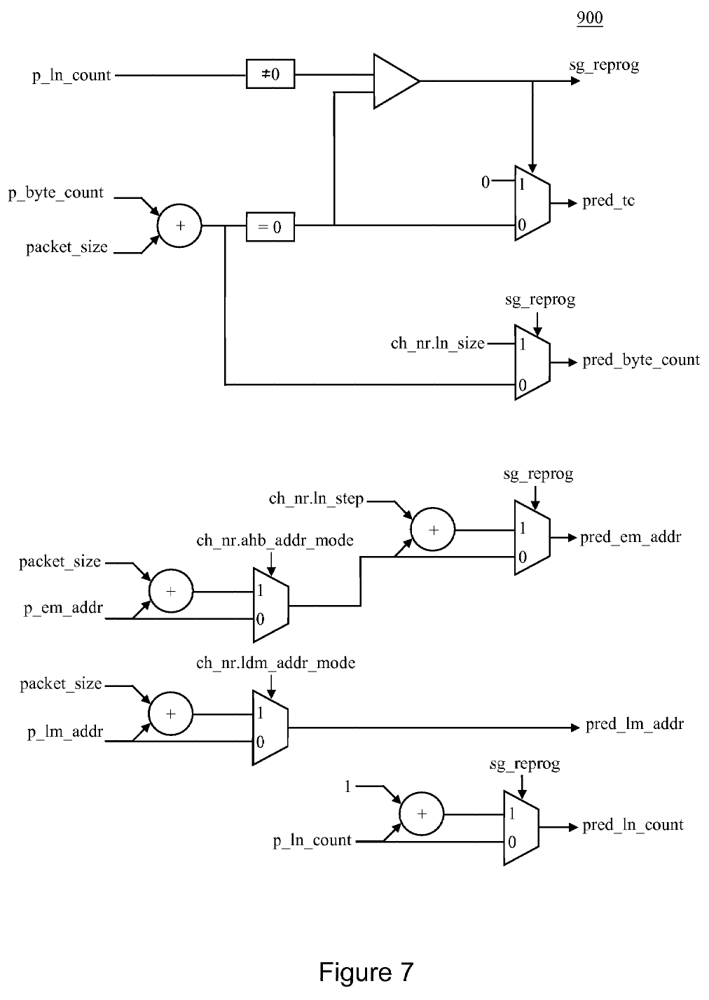

Referring now to FIG. 7, a schematic diagram of a channel parameter prediction unit 900 according to a preferred embodiment is illustrated. In the example, the channel parameter prediction unit 900 uses inputs to receive such as p_ln_count, p_byte_count, p_em_addr and p_lm_addr signals from the tail search unit, some of the actual channel parameters associated with the selected channel and the packet_size which is calculated in the cmd/req entry generator 222 as shown in FIG. 2 based on the selected channel's burst length and transfer size parameters and the p_byte_count value. It produces a new set of the predicted channel parameters associated with the new request that is being scheduled.

This feature increases the DMA controller's performance for memory-to-memory transfers as it enables the DMA controller to reduce the data packet processing latency that arises from the DMA controller monitoring the response signals associated with each data transfer over the system bus.

Although the present invention has been described in considerable detail with references to certain preferred embodiments thereof, other versions and variations are possible and contemplated. Moreover, although the present disclosure contemplates one implementation of outstanding request queue (reqQ), it may also be applied in a similar manner to use other register configurations to achieve similar results.

Finally, those skilled in the art should appreciate that they can readily use the disclosed conception and specific embodiments as a basis for designing or modifying other structures for carrying out the same purpose without departing from the spirit and scope of the present invention as defined by the appended claims.

What is claimed is:

1. A DMA controller, comprising:
a request queue configured to store at least one entry, each entry constituted of at least a predicted parameter value and a DMA channel number;
a tail search unit configured to search if a selected channel has requests outstanding in the request queue, wherein if any valid outstanding intra-channel request is found during the tail search then the tail search stops and the tail search unit outputs that entry's predicted parameter value, and if no valid outstanding intra-channel request is found during the tail search the tail search unit outputs the selected channel's actual channel parameter values;
a channel prediction unit configured to generate at least one new set of predicted channel parameters associated with a new request that is being scheduled according to the outputs from said tail search unit; and
a command/request entry generator sends the new request to said request queue based on the outputs of said tail search unit and said channel prediction unit.

2. The DMA controller according to claim 1, further comprising a request mask unit configured to receive a plurality of software requests and a plurality of hardware requests associated with a plurality of active DMA channels wherein said software requests and said hardware requests are being forwarded to a channel request arbiter for service.

3. The DMA controller according to claim 1, further comprising:
A plurality of channel configuration registers configured to store a plurality of active DMA channels and to output a set of actual channel parameters; and
a channel request arbiter configured to arbitrate among a plurality of active DMA transfer requests associated with all said active DMA channels in channel configuration registers and select the next DMA channel number to be serviced.

4. The DMA controller according to claim 3, wherein said channel request arbiter monitors all active requests from the request mask unit.

5. The DMA controller according to claim 1, wherein said predicted channel parameters comprise:
a predicted terminal count field for storing a predicted result if a particular channel hits its terminal count following a successful completion of the outstanding request;
a predicted byte count field for storing predicted remaining bytes to be sent following said successful completion of the outstanding request;
two predicted memory address fields for storing predicted source and destination memory address locations following said successful completion of the outstanding request; and
a predicted line count field for storing a predicted line segment counter value.

6. The DMA controller according to claim 1, wherein said tail search unit is a multiplexer.

7. The DMA controller according to claim 1, wherein said tail search unit comprises a tail search priority decoder that supports a multi-entry deep request queue, said tail search priority decoder receives said predicted channel parameter values, said channel number, and a plurality of valid bits, from the corresponding entries in the request queue, and said tail search priority decoder also receives said selected channel's actual channel parameter values.

8. The DMA controller according to claim 7, wherein said tail search unit produces a number of input parameters based on the most recently predicted intra-channel parameter values generated by said priority decoder.

9. The DMA controller according to claim 1, wherein said DMA controller is a fixed offset scatter/gather DMA controller.

10. The DMA controller according to claim 1, wherein said request is a software request.

11. An outstanding request queue of a DMA controller, comprising:
a predicted terminal count field for storing a predicted result if a particular channel hits its terminal count following a successful completion of the outstanding request;
a predicted byte count field for storing predicted remaining bytes to be sent following said successful completion of the outstanding request; and
two predicted memory address fields for storing predicted source and destination memory address locations following said successful completion of the outstanding request.

12. The outstanding request queue according to claim 11, further comprising a predicted line count field for storing a predicted line segment counter value.

13. The outstanding request queue according to claim 11, wherein said DMA controller is a fixed offset scatter/gather DMA controller.

14. A method for transferring multiple outstanding requests in a DMA controller, comprising:
storing at least one entry wherein each entry is constituted of at least a predicted parameter value and a DMA channel number;
tail searching if a selected channel has requests outstanding in the request queue, if any valid outstanding intra-channel request is found during the tail search then stops the tail search and outputs that entry's predicted parameter value, and if no valid outstanding intra-channel request is found during the tail search then outputs the selected channel's actual channel parameter values;
generating at least one new set of predicted channel parameters associated with a new request that is being scheduled according to said outputs from said tail searching step; and
sending said new request to a request queue based on said outputs of said tail searching step and said channel prediction generating step.

15. The method according to claim 14, wherein said request is a software request.

16. The method according to claim 14, further comprising receiving a plurality of software requests and a plurality of hardware requests associated with a plurality of active DMA channels and forwarding said software requests and said hardware requests to.

17. The method according to claim 14, further comprising:
storing a plurality of active DMA channels and outputting a set of actual channel parameters; and
arbitrating among a plurality of active DMA transfer requests associated with all active DMA channels and selecting the next DMA channel number to be serviced.

18. The method according to claim 14, wherein said predicted channel parameters comprise:
a predicted terminal count field for storing a predicted result if a particular channel hits its terminal count following a successful completion of the outstanding request;
a predicted byte count field for storing a predicted remaining bytes to be sent following said successful completion of the outstanding request;
two predicted memory address fields for storing predicted source and destination memory address locations following said successful completion of the outstanding request; and
a predicted line count field for storing a predicted line segment counter value.

19. The method according to claim 14, further comprising receiving said predicted channel parameter values, said channel number, and a plurality of valid bits from the corresponding entries in the request queue, and also receiving said selected channel's actual channel parameter values.

20. The method according to claim 19, further comprising producing a number of input parameters based on the most recently predicted intra-channel parameter values.
